(19) United States
(12) Patent Application Publication
(10) Pub. No.: US 2025/0108507 A1
(43) Pub. Date: Apr. 3, 2025

(54) METHOD, DEVICE AND MEDIUM FOR OPERATING ROBOT ARM

(71) Applicant: Beijing Youzhuju Network Technology Co., Ltd., Beijing (CN)

(72) Inventors: Hongtao WU, Beijing (CN); Ya JING, Beijing (CN); Chilam CHEANG, Beijing (CN); Guangzeng CHEN, Beijing (CN); Jiafeng XU, Beijing (CN); Tao KONG, Beijing (CN)

(21) Appl. No.: 18/774,064

(22) Filed: Jul. 16, 2024

(30) Foreign Application Priority Data
Sep. 28, 2023 (CN) 202311286388.1

(51) Int. Cl. B25J 9/16

(52) U.S. Cl. CPC B25J 9/1658; B25J 9/1664

(57) ABSTRACT

Methods, devices, and media for operating a robot arm are provided. In one method, receive a language description for specifying a target implemented by the robot arm; obtain a current state of the robot arm; and determine, according to an action model, an action to be performed by the robot arm based on the language description and the current state. With the example implementation of the present disclosure, the problem of insufficient training data of the robot arm may be alleviated. Further, the pre-trained action model may obtain the basic knowledge about the association relationship between the language description and the person action, may obtain a more accurate action model, and further obtain the action of the robot arm matching the language description in a more efficient manner.

### CROSS-REFERENCE

This application claims the benefit of CN Patent Application No. 2023112863881, filed on Sep. 28, 2023, entitled “METHOD, APPARATUS, DEVICE AND MEDIUM FOR OPERATING ROBOT ARM”, which is hereby incorporated by reference in its entirety.

### FIELD

Example implementations of the present disclosure generally relate to robot control, and in particular to methods, apparatuses, devices, and computer-readable storage media for operating a robot arm.

### BACKGROUND

In recent years, robot technology has been developed rapidly and has been widely used in many technical fields. For example, on a factory production line, a robot arm may be used to perform various tasks such as processing, grabbing, sorting, package, and the like. Further, machine learning technology has also been widely used in multiple application scenarios. At this time, it is expected that the robot technology and the machine learning technology may be combined to control the operations of the robot in a simpler and effective manner.

### SUMMARY

In a first aspect of the present disclosure, a method for operating a robot arm is provided. In the method, receiving a language description for specifying a target implemented by the robot arm; obtaining a current state of the robot arm; and determining, according to an action model, an action to be performed by the robot arm based on the language description and the current state.

In a second aspect of the present disclosure, an apparatus for operating a robot arm is provided. The apparatus includes: a receiving module configured to receive a language description for specifying a target implemented by the robot arm; an obtaining module, configured to obtain a current state of the robot arm; and a determining module, configured to determine, according to an action model, an action to be performed by the robot arm based on the language description and the current state.

In a third aspect of the present disclosure, an electronic device is provided. The electronic device includes: at least one processing unit; and at least one memory coupled to the at least one processing unit and storing instructions executed by the at least one processing unit, the instructions, when executed by the at least one processing unit, causing the electronic device to perform the method according to the first aspect of the present disclosure.

In a fourth aspect of the present disclosure, there is provided a computer-readable storage medium having a computer program stored, the computer program, when executed by a processor, causing the processor to implement the method the method according to the first aspect of the present disclosure.

It should be understood that the content described in this disclosure is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 shows a block diagram of an application environment using a robot arm according to an exemplary implementation of the present disclosure;

FIG. 2 illustrates a block diagram for operating a robot arm according to some implementations of the present disclosure;

FIG. 3 illustrates a block diagram of an input/output of an action model according to some implementations of the present disclosure;

FIG. 4 shows a block diagram of a structure of an action model according to some implementations of the present disclosure;

FIGS. 5A-5E show block diagrams of structures of various encoders and decoder in an action model according to some implementations of the present disclosure;

FIG. 6 shows a block diagram of a process of performing pre-training according to some implementations of the present disclosure;

FIG. 7 illustrates a block diagram of a correspondence between various data in a process of performing pre-training according to some implementations of the present disclosure;

FIG. 8 shows a block diagram of a process of performing fine-tuning according to some implementations of the present disclosure;

FIG. 9 shows a block diagram of a correspondence between various data in a process of performing fine-tuning according to some implementations of the present disclosure;

FIG. 10 shows a block diagram of an inference stage according to some implementations of the present disclosure;

FIG. 11 shows a block diagram of a comparison between a result obtained using an action model and an existing technical solution according to some implementations of the present disclosure;

FIG. 12 illustrates a block diagram of a comparison between results obtained using different manners to train an action model according to some implementations of the present disclosure;

FIG. 13 shows a flowchart of a method for operating a robot arm according to some implementations of the present disclosure;

FIG. 14 illustrates a block diagram of an apparatus for operating a robot arm according to some implementations of the present disclosure; and

FIG. 15 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include” and similar terms should be understood to include “including but not limited to”. The term “based on” should be understood as “based at least in part on”. The terms “one implementation” or “the implementation” should be understood as “at least one implementation”. The term “some implementations” should be understood as “at least some implementations”. Other explicit and implicit definition may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It should be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative and does not constitute a limitation on implementations of the present disclosure, and other manners of meeting related laws and regulations may also be applied to implementations of the present disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

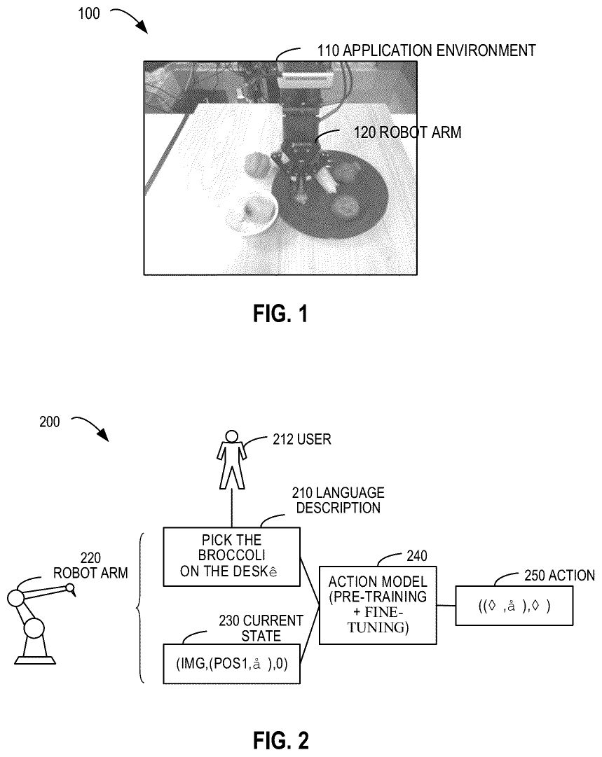

In recent years, the robot technology and machine learning technology have been widely used in multiple application scenarios. FIG. 1 shows a block diagram 100 of an application environment 110 using a robot arm according to an example implementation of the present disclosure. As shown in FIG. 1, in the application environment 110, the robot arm 120 may be used to operate various object in the application environment 110. Here, the object may be various fruits and/or vegetables, for example, the robot arm may be used to grasp and place object on the desktop into the tray; for another example, the robot arm may be used to place object in the tray to a specified location on the desktop, and so on.

Machine learning model for controlling robot actions based on visual data and language data have been developed. However, the accuracy and efficiency of the proposed solutions are not satisfactory. At this time, it is expected that the robot technology and the machine learning technology may be combined to control the operation of the robot in a simpler and effective manner.

### Summary of Operation Processes

In order to at least partially solve the deficiencies in the prior art, according to an exemplary implementation of the present disclosure, a method for operating a robot arm is provided. Referring to FIG. 2, a schematic diagram of an example implementation of the present disclosure is described, and FIG. 2 shows a block diagram 200 for operating a robot arm according to some implementations of the present disclosure. As shown in FIG. 2, the action of the robot arm 220 may be controlled based on the action model 240. For example, the user 212 may specify a language description 210 of a target implemented by the robot arm.

One example implementation according to the present disclosure will be described below in the English language environment. Alternatively, or in addition, technical solutions according to one example implementation of the present disclosure may be performed in other language environments. For example, the robot may be controlled in an environment such as Chinese, English, Japanese, French and the like. For example, the robot may be controlled in different languages based on the multi-language capability provided by the machine learning technology. For ease of description, in the following, the process of controlling the robot will be described only by taking and placing a certain object as an example. Alternatively, or in addition, the robot arm may perform other actions, for example, a robot arm may be utilized to process the part to a predetermined size, to package various items, and so on.

Further, the current state 230 of the robot arm 220 may be obtained. It should be understood that the current state 230 herein may include data of various aspects, such as image data of a robot arm, posture data of a robot arm, and a state of a tool (e.g., a clamp, a knife, and so on) secured at an end of the robot arm. The language description 210 and the current state 230 may be inputted to an action model 240 (e.g., a GR −1 model for short) to determine an action 250 to be performed by the robot arm 220 based on the language description 210 and the current state 230 using the action model 240. Here, act 250 may represent the difference between the current pose and the next pose of the robot arm, and the difference between the current state and the next state of the tool.

It should be understood that the action model 240 herein may be obtained based on a pre-training process and a fine-tuning process. Specifically, the action model 240 is pre-trained by reference data including related data of the robot arm, that is, the action model 240 is pre-trained by reference data that does not include related data of the robot arm. For example, the pre-training process may be performed using relevant data including language data and character actions. The problem that the training data of the robot arm is insufficient may be solved. Further, the pre-trained action model may grasp the basic knowledge about the association relationship between the language description and the person action. Further, in the fine-tuning process, the action model 240 may be further trained using relevant data of the robot arm. In this way, the action of the robot arm matching the language description may be obtained in a more efficient manner.

### Detailed Processes of Operation Processes

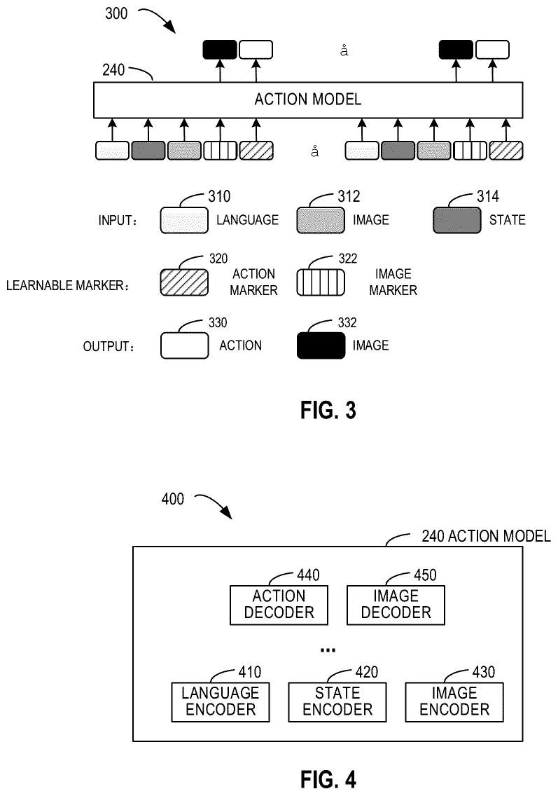

Having described a summary according to one example implementation of the present disclosure, more details according to one example implementation of the present disclosure will be described below. FIG. 3 illustrates a block diagram 300 of an input/output of an action model in accordance with some implementations of the present disclosure. As shown in FIG. 3, an input of the action model 240 and a learnable marker (token) are shown below the action model 240.

Specifically, the legend 310 represents language-related data, such as a language description for specifying a target implemented by a robot arm; the legend 312 represents image related data in a current state, such as image data collect by an image acquisition device above or near a robot arm; and the legend 314 represents related data for other states in a current state, for example, pose and tool state of a robot arm, and so on. With respect to learnable markers, the legend 320 may represent an action marker, for example, may be determined based on an action querier; and the legend 322 may represent an image marker, which may be determined, for example, based on an image analyzer.

According to one example implementation of the present disclosure, output data of the action model 240 is shown above the action model 240. For example, the legend 330 may represent a related action output by the action model 240, and the legend 330 may represent an image prediction of a scenario where the robot arm output by the action model 240 performs a related action, that is, a predicted corresponding scenario when the robot arm performs the action.

In the following, a structure of the action model 240 is described first. FIG. 4 shows a block diagram 400 of a structure of the action model according to some implementations of the present disclosure. As shown in FIG. 4, the action model 240 may include a language encoder 410, a state encoder 420, an image encoder 430, an action decoder 440, and an image decoder 450. It should be understood that FIG. 4 is merely illustrative, and the action model 240 may further include other network structures, and some network structures may be shared between the encoders and decoder.

It should be understood that the encoder and decoder described above may be used to process data during the training and inference of the action model 240. For example, in the training phase, these encoders and decoders may process data in the training data set (also referred to as reference data) and may process the currently collect data to be processed in the inference phase.

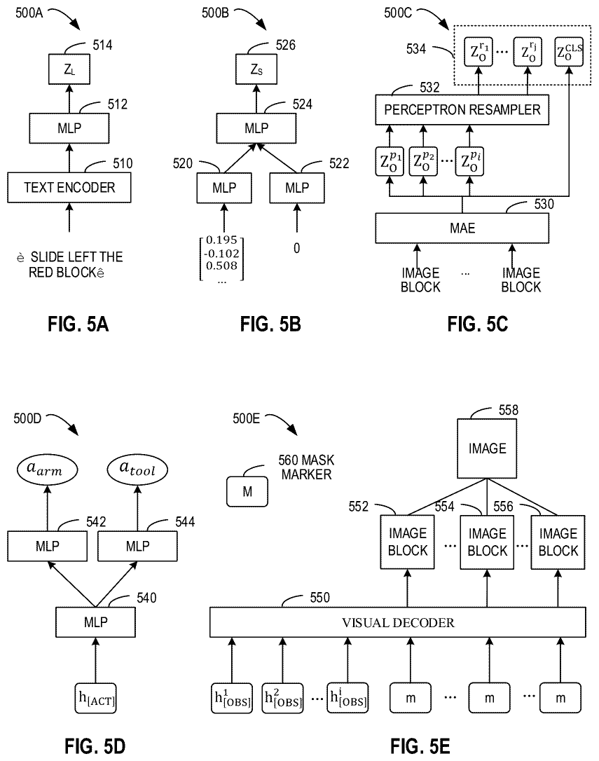

Further details according to one example implementation of the present disclosure are described with reference to FIGS. 5A-5E. FIG. 5A illustrates a block diagram 500A of a structure of a language encoder 410 in an action model according to some implementations of the present disclosure. As shown in FIG. 5A, the language encoder 410 may include a text encoder 510, a multilayer perceptron (MLP) 512, and corresponding features (e.g., embeds) 514. It should be understood that the text encoder 510 herein may be implemented based on a Contrastive Language Image Pre-training (CLIP) technique, for example. It should be understood that FIG. 5A is merely illustrative. Alternatively, or in addition, the language encoder 410 may include more, fewer, and/or different portions to extract features 514 from the input language description.

FIG. 5B illustrates a block diagram 500B of a structure of a state encoder 420 in an action model according to some implementations of the present disclosure. As shown in FIG. 5B, the state encoder 420 may include a plurality of MLP 520, 522, and 524. MLP 520 and MLP 522 may receive the pose of the robot arm and the state of the tool, respectively. According to an example implementation of the present disclosure, a posture of the robot arm may be described by using a vector including 6 degrees of freedom, for example, [pos₁, pos₂, pos₃, rot₁, rot₂, rot₃]. The first three dimensions in the vector represent the position of the robot arm, and the last three dimensions represent the orientation of the robot arm. The states of the tools may take different representation formats for different types of tools. Assuming the tool is a clamp, the state may include an open state indicated by 0, and a closed state indicated by 1. Assuming the tool is a drill bit, the state may include, for example, the speed and model of the tool, and so on.

The MLP 524 may receive the outputs of the MLP 520 and 522, thereby generating relevant features 526 of the state of the robot arm. It should be understood that FIG. 5B is merely illustrative. Alternatively, or in addition, the state encoder 420 may include more, fewer, and/or different portions to extract features 526 from the input state data.

FIG. 5C illustrates a block diagram 500C of a structure of an image encoder 430 in an action model according to some implementations of the present disclosure. As shown in FIG. 5C, the image encoder 430 may include a Masked Auto Encoder (MAE) and a perceptron resampler 532. The MAE 530 may receive one or more images and output corresponding features Zₒ^{p}^{₁}, Zₒ^{p}^{₂}, . . . , Zₒ^{p}^{ᵢ}, Zₒ^{CLS}. The perceptron resampler 532 may integrate various features Zₒ^{p}^{₁}, Zₒ^{p}^{₂}, . . . , Zₒ^{p}^{ᵢ}, thereby generating a smaller number of features Zₒ^{r}^{₁}, . . . , Zₒ^{r}^{ⱼ}. Further, the features Zₒ^{r}^{₁}, . . . , Zₒ^{r}^{ⱼ} and Zₒ^{CLS} may be connected, and then the connected feature is used as a feature of the image. It should be understood that FIG. 5C is merely illustrative. Alternatively, or in addition, image encoder 430 may include more, fewer, and/or different portions to extract features 534 from the input state data.

Specifically, the image frame data may be encoded by a pre-trained MAE. Zₒ^{CLS} marked correspondingly to the CLS is used as a global representation of the image. Zₒ^{p}^{₁}, Zₒ^{p}^{₂}, . . . , Zₒ^{p}^{ᵢ} marked correspondingly to the slice markers are used as local representations, they are further processed by the perceptron resampler to reduce the number of markers. In pre-training, there may be only one image at each point in time; during the fine-tuning, the image data may include images captured from a static photo acquisition device (e.g., at a fixed location near the robot arm) and a dynamic acquisition device (e.g., mounted at the robot arm end). The number of images may be adjusted flexibly.

FIG. 5D illustrates a block diagram 500D of a structure of an action decoder 440 in an action model according to some implementations of the present disclosure. As shown in FIG. 5D, action decoder 440 may include a plurality of MLP 540, 542, and 544. MLP 540 may receive action-related features, and MLP 542 and 544 may output features related to the pose of the robot arm aₐᵣₘ and features related to the tool state aₜₒₒₗ, respectively. It should be understood that FIG. 5D is merely illustrative. Alternatively, or in addition, the action decoder 430 may include more, fewer, and/or different portions in order to map the input feature data to respective actions.

FIG. 5E illustrates a block diagram 500E of a structure of an action image decoder 450 in an action model according to some implementations of the present disclosure. As shown in FIG. 5E, the image decoder 450 may include a visual decoder 550 that may receive various image related features and corresponding mask markers (e.g., 560) in order to output image blocks 552, . . . , 554, . . . , 556 respectively corresponding to respective masks, thereby generating a corresponding image 558. It should be understood that FIG. 5E is merely illustrative. Alternatively, or in addition, image decoder 450 may include more, fewer, and/or different portions in order to map input feature data to respective images.

Having described the structure of each encoder and decoder in the action model 240, the process for training the action model 240 will be described in detail below. It should be understood that the training process may include a pre-training process and a fine-tuning process. Specifically, the action model may be pre-trained to obtain the pre-trained action model by using the reference character video including the reference character action and the reference language description describing the character video. With example implementations of the present disclosure, the pre-training process may enable the action model 240 to master basic knowledge about language expressions and actions, thereby improving accuracy of a subsequent fine-tuning process.

First, introduction of symbols that may be used during training and reasoning is provided. The pre-training task may be generated as a video using language conditional video prediction. Specifically, the action model (including parameters) may be pre-trained, and in the case of a language description of a given video and a video frame sequence to a time point range, a corresponding video frame at a future time point may be predicted. As shown in formula 1 below:

$$π ( l , {o}_{t - h : t} ) \to {o}_{t + f} \qquad formula 1$$

In the above formula, w represents the parameter of the action model 240, l represents a language description, o represents an image of a video frame, t represents a current time point, o_{t-h:t} represents a video frame sequence in a previous time range before the current time point, and o_{t+f} represents an image of a corresponding video frame at a future time point t+f.

In the pre-training process, the action model 240 may be pre-trained using the collection including videos in the person's video data set and their related language descriptions. In this case, each training data in the data set may be represented in the following format:

$$v = \{ l , {o}_{1} , {o}_{2} , … , {o}_{T} \} \qquad formula 2$$

In the foregoing formula, v represents related training data (also referred to as reference data) of one video in the data set, l represents a language description of the video, o₁, o₂, . . . , o_{T} represents each video frame in the video, and T represents a quantity of video frame.

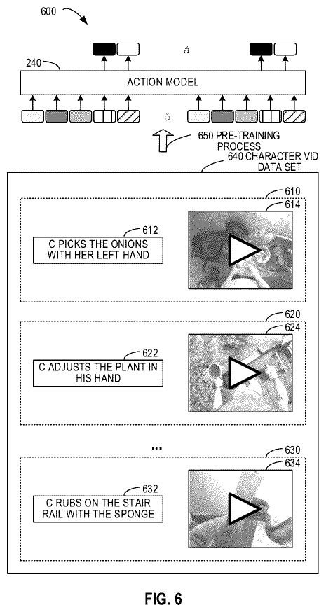

Further details regarding pre-training are described with reference to FIG. 6, which illustrates a block diagram 600 of a process of performing pre-training according to some implementations of the present disclosure. As shown in FIG. 6, the character video data set 640 for the pre-training process 650 may include a plurality of reference character videos and corresponding reference language descriptions. For example, reference data 610 may include reference character video 614 and reference language description 612; reference data 620 may include reference character video 624 and reference language description 622; . . . , reference data 630 may include reference character video 634 and reference language description 632.

Each reference character video may relate to the same or different purposes, such as, for example, a character holding an onion with a left hand of in the reference character video 614, a character adjusting a plant in a hand in the reference character video 624, . . . , a character using a sponge to wipe the handrail of the stairs in the reference character video 634. According to an example implementation of the present disclosure, corresponding data may be extracted from each reference data, and input to the action model 240 to obtain a corresponding prediction value.

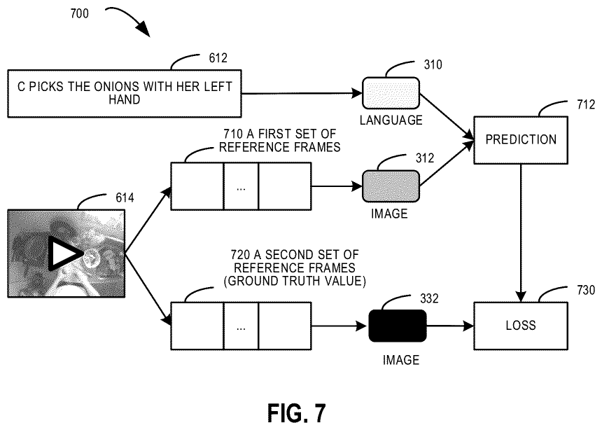

Further details regarding determining the loss function in turn updating the action model 240 are described with reference to FIG. 7. FIG. 7 shows a block diagram 700 of performing a correspondence between various data in a pre-trained process according to some implementations of the present disclosure. In FIG. 7, a pre-training process is described with reference to data 610 as an example. Specifically, in the process of pre-training the action model 240, the first set of reference frames 710 and the second set of reference frames 720 after the first set of reference frames 710 may be extracted from the reference character videos 614 respectively.

It should be understood that, in this case, the first set of reference frames 710 includes different numbers of video frames, for example, the first set of reference frames 710 may include the (t-h)^{th} video frame to the (t)^{th} video frame in the video (which may represent a pre-specified positive integer). The second set of reference frames 720 may include one or more video frames at different points in time, e.g., a video frame(s) at the time point t+f (f may represent a pre-specified positive integer here). For ease of description, hereinafter, only one video frame is included in the second set of reference frames 720 as an example for description. in a case that the second set of reference frames 720 includes multiple video frame, each video frame may be determined in a similar manner.

The prediction 712 of the second set of reference frames 720 may be determined using the action model 240 based on the reference language description 612 (corresponding to the legend 310) and the first set of reference frames 710 (corresponding to the legend 312). Further, the action model 240 may be updated based on a loss 730 between the prediction 712 of the second set of reference frames and the second set of reference frames 720 (i.e., ground truth values, corresponding to the legend 332) (for a better discussion, this loss may be referred to as a first loss, e.g., represented as L_{video1}).

It should be understood that because the quantity of training data related to the robot arm and the action type of the robot arm are relatively limited, the association relationship between the language description and the action of the robot arm cannot be effectively extracted by using the training dataset of the robot arm. With the example implementation of the present disclosure, by using the training data set including the character video data, the pre-training process may enable the action model 240 to learn about the relevant knowledge about the rich action, thereby more helping to improve the accuracy of the action model 240 in the subsequent fine-tuning process.

Further, a reference robot arm video including a reference robot arm action and a reference action language description describing the robot arm video may be used to fine-tune the pre-trained action model to obtain a fine-tuned action model. With example implementations of the present disclosure, on the basis of the pre-training process, data related to the robot arm may be used to further optimize the parameters of the action model 240, thereby improving the accuracy of the action model 240.

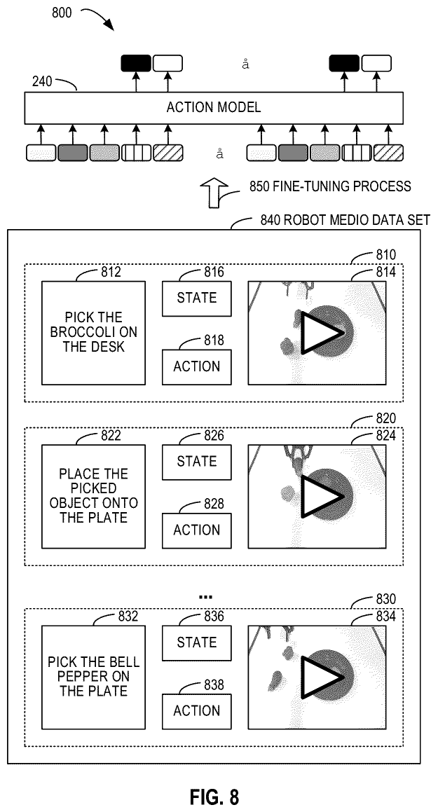

FIG. 8 shows a block diagram 800 of a process of performing fine-turning according to some implementations of the present disclosure. As shown in FIG. 8, the robot video data set 840 for the fine-tuning process 850 may include video of multiple reference robots and corresponding reference action language descriptions. Further, more relevant information of the robot arm, such as the status of the robot arm and the action to be performed, may be included. For example, reference data 810 may include reference robot video 814, reference action language description 812, state 816, and action 818; reference data 820 may include reference character video 824, reference language description 822, state 826, and action 828; . . . , reference data 830 may include reference character video 834, reference language description 832, state 836, and action 838.

According to an example implementation of the present disclosure, the state herein may include at least one of the following: a reference posture of the reference robot arm and a reference state of a reference tool of the reference robot arm. For example, the state may be represented based on the vector format described above. According to an example implementation of the present disclosure, the reference action relates to at least one of the following: a change of a reference posture and a reference state. For a gesture, a change in the above 6 degrees of freedom may be involved; for the state of the tool, a change in the switch state of the clamp may be included, e.g., from open ->closed, and so on.

The individual videos may refer to the same or different purposes, for example, a robot arm in the reference robot video 814 picking up the broccoli, the robot arm in the reference robot video 834 placing the item on the tray, . . . , the robot arm in the reference robot video 824 placing green pepper on the tray. According to an example implementation of the present disclosure, corresponding data may be extracted from each video, and input to the action model 240 to obtain a corresponding fine adjustment.

According to an example implementation of the present disclosure, the manner of determining the loss related to the video portion in the fine adjustment process is similar to the manner shown in FIG. 7, and details are not described herein again. Specifically, the fourth set of reference frames after the third set of reference frames and the third set of reference frames may be extracted from the reference robot arm video, respectively. A pre-trained action model may be utilized to determine a prediction of a fourth set of reference frames (i.e., ground truth values) based on the reference action language description and the third set of reference frames. Further, the action model may be updated based on a loss between a fourth set of reference frames and a fourth set of reference frames (for a better discussion, this loss may be referred to as a second loss, for example, represented as L_{video2}).

Further, in the fine-tuning process, states and actions in the reference data may be used to determine the loss function accordingly. Hereinafter, the related process will be described with reference to data 810 as an example. Specifically, a reference current state describing the reference robot arm (e.g., state 816 in FIG. 8) and a reference action (e.g., action 818 in FIG. 8) may be obtained. Further, a pre-trained action model may be utilized to determine a prediction of the reference action based on the reference current state, the reference action language description, and the third set of reference frames, and to update the action model based on a third loss between the prediction of the reference action and the reference action.

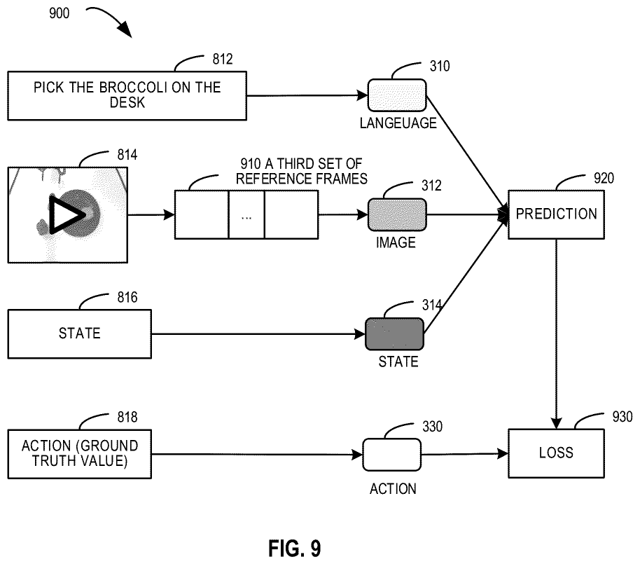

FIG. 9 shows a block diagram 900 of a correspondence between various data in a process of performing fine-tuning according to some implementations of the present disclosure. As shown in FIG. 9, predictions 920 of actions may be determined using reference action language description 812 (corresponding to legend 310), a third set of reference frames 910 (corresponding to legend 312) extracted from reference robot video 814, state 816 (corresponding to legend 314). Further, a respective loss 930 may be determined based on a difference between the ground truth value of action 818 and the prediction 920, thereby updating the action model 240 with the loss 930. Here, the loss 930 may involve multiple aspects, such as a loss of pose associated with the robot arm Lₐᵣₘ, and a loss associated with the tool Lₜₒₒₗ.

According to one example implementation of the present disclosure, the first number of the first set of reference frames may be equal to the third number of the third set of reference frames, and the second number of the second set of reference frames may be equal to the fourth number of the fourth set of reference frames. That is, in the pre-training process and the fine-tuning process, the format of the corresponding video frame set is the same. In this way, the action model 240 may be trained in a unified manner, thereby improving the performance of the action model 240.

According to an example implementation of the present disclosure, the fine-tuning process involves a multitasking model, and the fine-tuning process may be continued for the pre-trained action model 240 described above (that is, the action model 240 in the initial phase of the fine-tuning process shares the same model parameter with the pre-trained action model 240). Specifically, the fine-tuning process may be performed based on the following formula:

$$π ( l , {o}_{t - h : t} , {s}_{t - h : t} ) \to {a}_{t} , {o}_{t + f} \qquad formula 3$$

In the above formula, s_{t-h:t} represents the robot arm state in a previous time range before the current time point, aₜ represents the action to be performed by the robot arm, and the meanings of the other parameters are the same as those in the formulas described above. Specifically, the training data set D={τᵢ}ᵢ₌₁^{N} including N pieces of reference data (that is, the track) of M different tasks may be accessed, and each track may include a language representation, a video frame sequence, a state, and an action:

$$τ = \{ l , {o}_{1} , {s}_{1} , {a}_{1} , {o}_{2} , {s}_{2} , {a}_{2} , … , {o}_{T} , {s}_{T} , {a}_{T} \} \qquad formula 4$$

According to an example implementation of the present disclosure, before being input to the converter, the feature dimension of each modality may be determined by a linear layer. For action prediction, the pose of the robot arm and the state of the tool may be prediction separately. For simplicity, the action is referred to as [ACT]. For image prediction, future frames may be predicted. For simplicity, the image is referred to as [OBS]. During pre-training, the markers may be arranged in the following order:

$$( l , {o}_{t - h} , [ OBS ] , l , {o}_{t - h + 1} , [ OBS ] , … , l , {o}_{t} , [ OBS ] , ) \qquad formula 5$$

During fine-tuning, the markers may be arranged in the following order:

$$( l , {s}_{t - h} , {o}_{t - h} , [ OBS ] , [ ACT ] , l , {s}_{t - h + 1} , … , l , {s}_{t} , {o}_{t} , [ OBS ] , [ ACT ] ) \qquad formula 6$$

It will be appreciated that language marker repeats in each time step to avoid overwhelming by other modalities. To account for time information, time features may be added to the markers. Within one time step, all devices may share the same time feature. Since the markers of different modalities are encoded in different manners, there is no need to add embeddings to disambiguate the modality. A causal attention mechanism may be employed. That is, during pre-training, all markers including marker [OBS] can only handle all language and image marker, and cannot handle past [OBS] marker. In the fine-tuning process, all markers (including markers [ACT] and markers [OBS]) can only handle relevant marker of language, image, and status, and cannot handle past markers [ACT] or [OBS].

The output from the marker [ACT] passes through the linear layer to prediction the action of the robot arm and tool (as described above with reference to FIG. 5D). Specifically, the decoder may be implemented using a self-attention module and an MLP module. The image decoder performs operations for outputs corresponding to [OBS] and mask marker (as described above with reference to FIG. 5D). Each mask marker is a shared learnable vector corresponding to positional encoding. The output of the predicted future image is reconstructed corresponding to the output of the mask marker.

According to one example implementation of the present disclosure, the pre-training process may be performed using publicly available Ego4D datasets (or other datasets). In the fine-tuning process, video of the robot data set may be sampled, and end-to-end optimization is performed by using causal behavior cloning loss and video prediction loss. Specifically, the loss function is as follows:

$$L = {L}_{arm} + {λ}_{1} {L}_{tool} + {λ}_{2} {L}_{video 2} \qquad formula 7$$

Specifically, images may be predicted in subsequent step f=3 for image prediction and supervised using MSE (mean square error) loss. For the pose of the robot arm, the action of the robot arm can be learned using the Smooth-L1 loss. For the state of the tool, a binary cross entropy (BCE) loss may be used. In the above formula, the λ₁ and λ₂ represent predetermined weight coefficients, for example, may be set to 0.01, 0.1, or another value, respectively.

According to one example implementation of the present disclosure, the action model 240 may be pre-trained, and the action model 240 may be used directly in the inference phase to perform the desired task. For example, at the positions shown in legend 310, legend 312 and legend 314, the input language description in the action model 240, the image data in the current state, and the data of the robot arm may be acquired, and then the corresponding action is acquired at the output position shown in legend 330 of the action model 240. Alternatively, or in addition, the corresponding image prediction may be acquired at the output position shown in FIG. 332 of the action model 240.

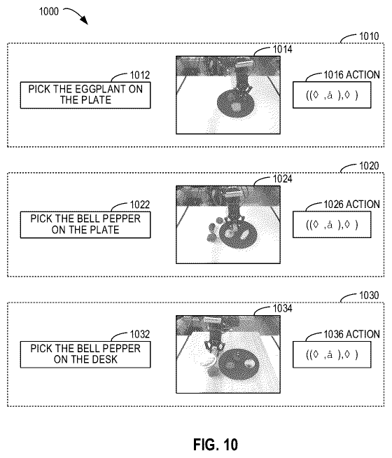

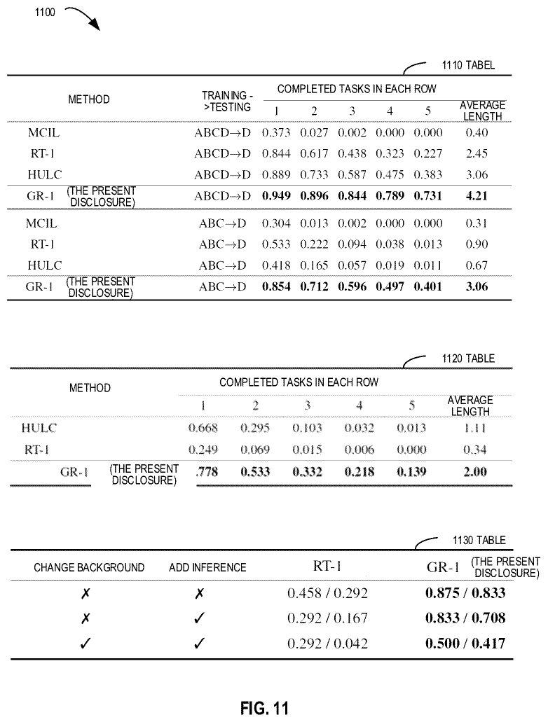

With example implementations of the present disclosure, knowledge in the action model 240 may be leveraged to prediction actions and corresponding images when a certain goal is achieved by the robot arm. Further details of the inference phase are described with reference to FIG. 10, which illustrates a block diagram 1000 of an inference phase in accordance with some implementations of the present disclosure. According to an example implementation of the present disclosure, the technical solutions described above may be applied in different situations. For example, the pre-training and fine-tuning may be performed with a large amount of data (e.g., all training data in the dataset) to obtain the action model 240. As shown in FIG. 10, the inference process 1010 represents performing inference using the action model 240 described above. Specifically, after inputting the language expression 1012 and the current state of the corresponding robot arm to the fine-tuned action model 240, the result outputted by the action model 240 is obtained. An action 1016 represents an action to be performed by the robot arm, and the image prediction 1014 represents an image prediction of the robot arm in grasping eggplants in the disc.

For example, interference factors may be added to the surrounding environment of the robot arm (e.g., changing the background of the tabletop, and/or adding a large number of fruits and/or vegetables to the tray, and so on). Inference process 1020 represents a process in the presence of interference factors. In this case, the action 1026 represents an action of the robot arm corresponding to the language expression 1022, and the image prediction 1024 represents image prediction when the robot arm grasps the green pepper in the tray in the presence of interference.

As another example, the pre-training and fine-tuning may be performed with a small amount of data (e.g., 10% in a dataset or other proportion of training data) to obtain the action model 240. The inference process 1030 represents performing inference using the action model 240 described above. Specifically, after inputting the language expression 1032 and the current state of the corresponding robot arm to the fine-tuned action model 240, the result outputted by the action model 240 is obtained. Action 1036 represents an action to be performed by the robot arm, and image prediction 1034 represents image prediction of the robot arm in grasping green pepper in the disc. As can be seen in FIG. 10, an example implementation in accordance with the present disclosure may achieve a better effect in a variety of situations.

According to one example implementation of the present disclosure, a location (e.g., a parameter f described above) for specifying a step of an action performed by a robot arm is received. Further, an action and an image prediction matching the number of steps may be determined according to the action model. As another example, the number of steps of the action performed by the robot arm may be specified, e.g., it may be specified that the output corresponds to the action and image prediction of f and f+1. In this way, existing knowledge in the action model 240 may be facilitated to prediction relevant information at different locations (i.e., time points).

According to an example implementation of the present disclosure, the current state of the robot arm includes at least one of the following: an image, a posture of the robot arm, and a state of a tool of the robot arm, and the action relates to a change in a posture and a state of the tool. In this way, the accuracy of the prediction result can be improved based on the current aspects.

According to an example implementation of the present disclosure, in a process of determining an action, a language encoder may be used to determine a language representation of a language description, a state encoder is used to determine a state representation of a current state, and then an action decoder is used to determine an action based on the language representation and the state representation. According to an example implementation of the present disclosure, in the process of determining the image prediction, the image decoder may be used to determine the image prediction based on the language representation and the state representation. In this way, the desired prediction task may be performed with an encoder-decoder architecture that has been verified to be reliable.

It should be understood that while the process of operating the robot arm is described above as an example to perform the training and reasoning processes in a real application environment. Alternatively, or in addition, the processes described above may be applied in a virtual application environment. For example, the robot arm may be operated in virtual manufacturing, virtual assembly, and other virtual simulation applications. In this case, the action model matches an application environment of the robot arm, and the application scenario includes at least one of the following: a virtual application environment and a real application environment.

In other words, if it is desired to perform the technical solutions of the present disclosure in a real application environment (for example, a real physical environment, such as a factory production line), the video data collect in the real application environment may be used to perform the pre-training and fine-tuning processes. If it is desired to perform the technical solutions of the present disclosure in a virtual application environment, the video data collect in the virtual application environment may be used to perform the pre-training and fine-tuning processes. In this way, the accuracy of the action model 240 can be improved, thereby improving the accuracy of the subsequent inference stage.

According to one example implementation of the present disclosure, an action from the action model 240 may be utilized to directly drive the robot arm. Alternatively, or in addition, the actions may be adjusted to determine action instructions for driving the robot arm in order to obtain more accurate action instructions. For example, it is assumed that there may be an error in the robot arm directly using the obtained action, for example, the robot arm cannot accurately grab a certain object, and at this time, the posture of the robot arm and the state of the tool may be adjusted accordingly, so as to obtain a more accurate robot arm trajectory, thereby determining a more accurate action instruction.

According to an example implementation of the present disclosure, a technical solution according to an example implementation of the present disclosure may obtain a better technical effect. FIG. 11 shows a block diagram 1100 of a comparison between a result obtained using an action model and an existing technical solution according to some implementations of the present disclosure. As shown in FIG. 11, Table 1110 shows the results of multi-task learning in the ABCD→D scenario (i.e., the training data relates to scenario ABCD and the test data relates to scenario D), Table 1120 shows the processing results in a small amount of training data (e.g., 10% training data) scenario, and Table 1130 shows the test results in the real robot experiment case. As can be seen from FIG. 11, a better technical effect can be obtained according to an example implementation of the present disclosure.

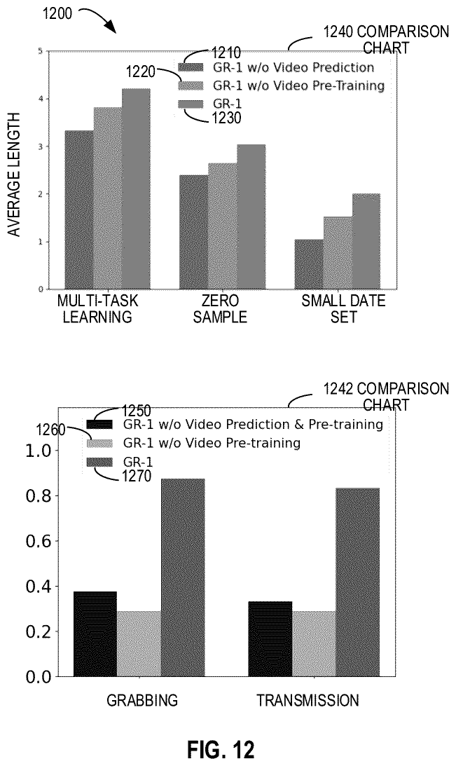

Further, FIG. 12 illustrates a block diagram 1200 of a comparison between results obtained using different manners to train an action model according to some implementations of the present disclosure. As shown in FIG. 12, in the comparison diagram 1240, legend 1210 shows the effect of the action model obtained without using video prediction and pre-training, legend 1220 shows the effect of the action model obtained without using video pre-training, and legend 1230 shows the effect of the action model obtained using video prediction and video pre-training. Further, in the comparison diagram 1242, legend 1250 shows the effect of the action model obtained without using video prediction and pre-training, legend 1260 shows the effect of the action model obtained without using video pretraining, and legend 1270 shows the effect of the action model obtained using video prediction and video pretraining. It can be seen that when video prediction and video prediction are used, a better effect can be obtained.

### Example Processes

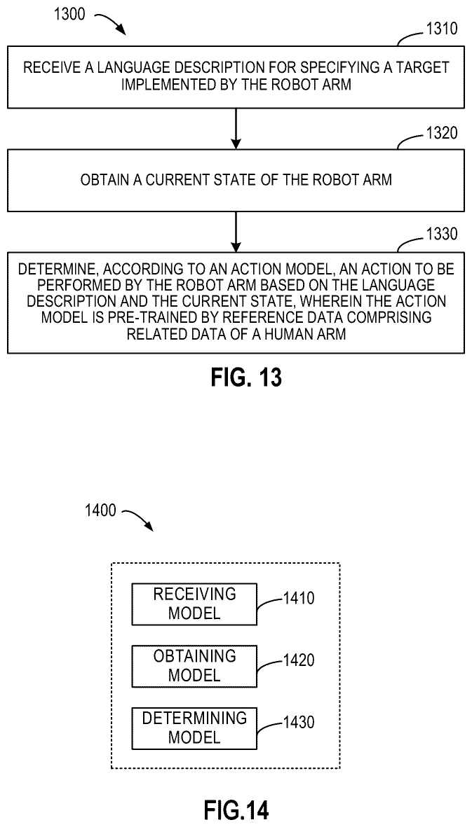

FIG. 13 shows a flowchart of a method 1300 for operating a robot arm according to some implementations of the present disclosure. At block 1310, receive a language description for specifying a target implemented by the robot arm. At lock 1320, obtain a current state of the robot arm. At block 1030, determine, according to an action model, an action to be performed by the robot arm based on the language description and the current state, wherein the action model is pre-trained by reference data comprising related data of a character arm.

According one example implementation of the present disclosures, the method 1300 further comprises: determining, according to the action model, image prediction of a scenario in which the robot arm performs the action based on the language description and the current state.

According one example implementation of the present disclosures, the method 1300 further comprises: receiving positions and the number of steps for specifying an action performed by the robot arm; and determining, according to the action model, an action matching the positions and the number of the steps and the image prediction.

According one example implementation of the present disclosures, the current state of the robot arm comprises at least one of: an image of the robot arm, a pose of the robot arm, and a state of a tool of the robot arm, the action relating to a change in the pose and the state of the tool.

According one example implementation of the present disclosures, the action model comprises a language encoder, a state encoder, and an action decoder, wherein determining the action comprises: determining a language representation of the language description with the language encoder; determining a state representation of the current state with the state encoder; and determining, based on the language representation and the state representation, the action with the action decoder.

According one example implementation of the present disclosures, the action model further comprises an image decoder, and determining the image prediction comprises: determining, based on the language representation and the state representation, the image prediction with the image decoder.

According one example implementation of the present disclosures, the action model is obtained based on: pre-training, with a reference character video including a reference character action and a reference language description describing the reference character video, the action model to obtain a pre-trained action model; and fine-tuning, with a reference robot arm video including a reference robot arm action and a reference action language description describing the robot arm video, the pre-trained action model to obtain a fine-tuned action model.

According one example implementation of the present disclosures, pre-training the action model comprises: extracting, from the reference character video, a first set of reference frames and a second set of reference frames after the first set of reference frames, respectively; and determining, based on the reference language description and the first set of reference frames, a prediction of the second set of reference frames with the action model; and updating the action model based on a first loss between the prediction of the second set of reference frames and the second set of reference frames.

According one example implementation of the present disclosures, fine-tuning the pre-trained action model comprises: extracting, from the reference robot arm video, a third set of reference frames and a fourth set of reference frames after the third set of reference frames, respectively; and determining, based on the reference action language description and the third set of reference frames, a prediction of the fourth set of reference frames with the pre-trained action model; and updating the action model based on a second loss between the prediction of the fourth set of reference frames and the fourth set of reference frames.

According one example implementation of the present disclosures, fine-tuning the pre-trained action model further comprises: obtaining a reference current state and a reference action of the reference robot arm; and determining, with the pre-trained action model, a prediction of the reference action based on the reference current state, the reference action language description, and the third set of reference frames; and updating the action model based on a third loss between the prediction of the reference action and the reference action.

According one example implementation of the present disclosures, the reference current state comprises at least one of: a reference pose of the reference robot arm or a reference state of a reference tool of the reference robot arm, and the reference action relates to at least one of: a change in the reference pose and the reference state.

According one example implementation of the present disclosures, the first number of the first set of reference frames equals to the third number of the third set of reference frames and the second number of the second set of reference frames equals to the fourth number of the fourth set of reference frames.

According one example implementation of the present disclosures, the action model matches an application environment of the robot arm, and the application environment comprises at least one of the following: a virtual application environment and a reality application environment.

According one example implementation of the present disclosures, the method 1300 further comprises, adjusting the action to determine an action instruction for driving the robot arm.

According one example implementation of the present disclosures, the action model is pre-trained by reference data comprising related data of a character arm.

### Example Apparatuses and Devices

FIG. 14 shows a block diagram of an apparatus 1400 for operating a robot arm according to some implementations of the present disclosure. The apparatus includes: a receiving module 1410 configured to receive a language description for specifying a target implemented by the robot arm; an obtaining module 1420, configured to obtain a current state of the robot arm; and a determining module 1430, configured to determine, according to an action model, an action to be performed by the robot arm based on the language description and the current state

According one example implementation of the present disclosures, the apparatus 1400 further comprises: a predicting model being configured to determine, according to the action model, image prediction of a scenario in which the robot arm performs the action based on the language description and the current state.

According one example implementation of the present disclosures, the apparatus 1400 further comprises: a parameter receiving model, being configured to receive positions and the number of steps for specifying an action performed by the robot arm; and determining, according to the action model, an action matching the positions and the number of the steps and the image prediction.

According one example implementation of the present disclosures, the current state of the robot arm comprises at least one of: an image of the robot arm, a pose of the robot arm, and a state of a tool of the robot arm, the action relating to a change in the pose and the state of the tool.

According one example implementation of the present disclosures, the action model comprises a language encoder, a state encoder, and an action decoder, wherein determining the action comprises: determining a language representation of the language description with the language encoder; determining a state representation of the current state with the state encoder; and determining, based on the language representation and the state representation, the action with the action decoder.

According one example implementation of the present disclosures, the action model further comprises an image decoder, and determining the image prediction comprises: determining, based on the language representation and the state representation, the image prediction with the image decoder.

According one example implementation of the present disclosures, the apparatus further comprises: a pre-training model being configured to pre-train, with a reference character video including a reference character action and a reference language description describing the reference character video, the action model to obtain a pre-trained action model; and fine-tuning, with a reference robot arm video including a reference robot arm action and a reference action language description describing the robot arm video, the pre-trained action model to obtain a fine-tuned action model.

According one example implementation of the present disclosures, the pre-training model comprises: a first extracting model being configured to extract, from the reference character video, a first set of reference frames and a second set of reference frames after the first set of reference frames, respectively; and a first prediction model being configured to determine, based on the reference language description and the first set of reference frames, a prediction of the second set of reference frames with the action model; and a first updating model being configured to update the action model based on a first loss between the prediction of the second set of reference frames and the second set of reference frames.

According one example implementation of the present disclosures, the fine-tuning model comprises: a second extracting model being configured to extract, from the reference robot arm video, a third set of reference frames and a fourth set of reference frames after the third set of reference frames, respectively; and a second prediction model being configured to determine, based on the reference action language description and the third set of reference frames, a prediction of the fourth set of reference frames with the pre-trained action model; and a second updating model being configured to update the action model based on a second loss between the prediction of the fourth set of reference frames and the fourth set of reference frames.

According one example implementation of the present disclosures, the fine-tuning model comprises: an action obtaining model being configured to obtain a reference current state and a reference action of the reference robot arm; and a third prediction model being configured to determine, with the pre-trained action model, a prediction of the reference action based on the reference current state, the reference action language description, and the third set of reference frames; and a third updating model being configured to update the action model based on a third loss between the prediction of the reference action and the reference action.

According one example implementation of the present disclosures, the reference current state comprises at least one of: a reference pose of the reference robot arm or a reference state of a reference tool of the reference robot arm, and the reference action relates to at least one of: a change in the reference pose and the reference state.

According one example implementation of the present disclosures, the first number of the first set of reference frames equals to the third number of the third set of reference frames and the second number of the second set of reference frames equals to the fourth number of the fourth set of reference frames.

According one example implementation of the present disclosures, the action model matches an application environment of the robot arm, and the application environment comprises at least one of the following: a virtual application environment and a reality application environment.

According one example implementation of the present disclosures, the apparatus further comprises an adjusting model being configured to adjust the action to determine an action instruction for driving the robot arm.

According one example implementation of the present disclosures, the action model is pre-trained by reference data comprising related data of a character arm.

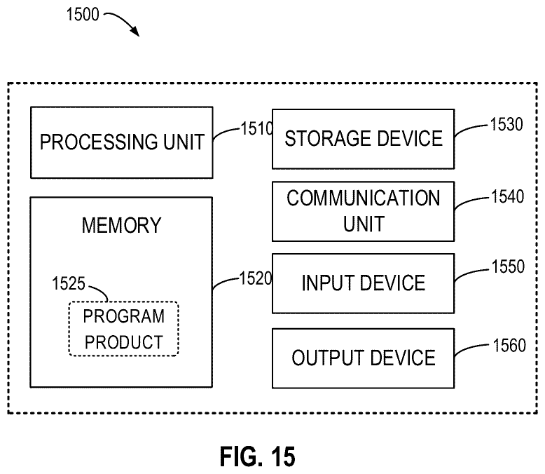

FIG. 15 illustrates a block diagram of a device 1500 capable of implementing various implementations of the present disclosure. It should be understood that the computing device 1500 shown in FIG. 15 is merely exemplary and should not constitute any limitation on the functionality and scope of the implementations described herein. The computing device 1500 shown in FIG. 15 may be configured to implement the method described above.

As shown in FIG. 15, the computing device 1500 is in the form of a general-purpose computing device. Components of the computing device 1500 may include, but are not limited to, one or more processors or processing units 1510, a memory 1520, a storage device 1530, one or more communication units 1540, one or more input devices 1550, and one or more output devices 1560. The processing unit 1510 may be an actual or virtual processor and capable of performing various processes according to programs stored in the memory 1520. In multiprocessor system, multiple processing units execute computer-executable instructions in parallel to improve parallel processing capabilities of computing device 1500.

Computing device 1500 typically includes a plurality of computer storage media. Such media may be any available media accessible by the computing device 1500, including, but not limited to, volatile and non-volatile media, removable and non-removable media. The memory 1520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1530 may be a removable or non-removable medium and may include a machine-readable medium, such as a flash drive, magnetic disk, or any other medium, which may be capable of storing information and/or data (e.g., training data for training) and may be accessed within computing device 1500.

The computing device 1500 may further include additional removable/non-removable, volatile/non-volatile storage media. Although not shown in FIG. 15, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 1520 may include a computer program product 1525 having one or more program modules configured to perform various methods or actions of various implementations of the present disclosure.

The communications unit 1540 implements communications with other computing devices over a communications medium. Additionally, the functionality of components of the computing device 1500 may be implemented in a single computing cluster or multiple computing machines capable of communicating over a communication connection. Thus, the computing device 1500 may operate in a networked environment using logical connections with one or more other servers, network personal computers (PCs), or another network Node.

The input device 1550 may be one or more input devices, such as a mouse, a keyboard, a trackball, or the like. The output device 1560 may be one or more output devices, such as a display, a speaker, a printer, or the like. Computing device 1500 may also communicate with one or more external devices (not shown) as needed, external devices such as storage devices, display devices, and so on, communicate with one or more devices that enable a user to interact with computing device 1500, or communicate with any device (e.g., network card, modem, and so on) that enables computing device 1500 to communicate with one or more other computing devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above. According to example implementations of the present disclosure, there is provided a computer program product having stored thereon a computer program, which when executed by a processor, implements the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for operating a robot arm, comprising:
receiving a language description for specifying a target implemented by the robot arm;
obtaining a current state of the robot arm; and
determining, according to an action model, an action to be performed by the robot arm based on the language description and the current state, wherein the action model is pre-trained by reference data comprising related data of a character arm.

2. The method of claim 1, further comprising: determining, according to the action model, image prediction of a scenario in which the robot arm performs the action based on the language description and the current state.

3. The method of claim 2, further comprising:
receiving positions and the number of steps for specifying an action performed by the robot arm; and
determining, according to the action model, an action matching the positions and the number of the steps and the image prediction.

4. The method of claim 1, wherein the current state of the robot arm comprises at least one of: an image of the robot arm, a pose of the robot arm, and a state of a tool of the robot arm, the action relating to a change in the pose and the state of the tool.

5. The method of claim 2, wherein the action model comprises a language encoder, a state encoder, and an action decoder, wherein determining the action comprises:
determining a language representation of the language description with the language encoder;
determining a state representation of the current state with the state encoder; and
determining, based on the language representation and the state representation, the action with the action decoder.

6. The method of claim 5, wherein the action model further comprises an image decoder, and determining the image prediction comprises: determining, based on the language representation and the state representation, the image prediction with the image decoder.

7. The method of claim 2, wherein the action model is obtained based on:
pre-training, with a reference character video including a reference character action and a reference language description describing the reference character video, the action model to obtain a pre-trained action model; and
fine-tuning, with a reference robot arm video including a reference robot arm action and a reference action language description describing the robot arm video, the pre-trained action model to obtain a fine-tuned action model.

8. The method of claim 7, wherein pre-training the action model comprises:
extracting, from the reference character video, a first set of reference frames and a second set of reference frames after the first set of reference frames, respectively; and
determining, based on the reference language description and the first set of reference frames, a prediction of the second set of reference frames with the action model; and
updating the action model based on a first loss between the prediction of the second set of reference frames and the second set of reference frames.

9. The method of claim 8, wherein fine-tuning the pre-trained action model comprises:
extracting, from the reference robot arm video, a third set of reference frames and a fourth set of reference frames after the third set of reference frames, respectively; and
determining, based on the reference action language description and the third set of reference frames, a prediction of the fourth set of reference frames with the pre-trained action model; and
updating the action model based on a second loss between the prediction of the fourth set of reference frames and the fourth set of reference frames.

10. The method of claim 9, wherein fine-tuning the pre-trained action model further comprises:
obtaining a reference current state and a reference action of the reference robot arm; and
determining, with the pre-trained action model, a prediction of the reference action based on the reference current state, the reference action language description, and the third set of reference frames; and
updating the action model based on a third loss between the prediction of the reference action and the reference action.

11. The method of claim 10, wherein the reference current state comprises at least one of: a reference pose of the reference robot arm or a reference state of a reference tool of the reference robot arm, and the reference action relates to at least one of: a change in the reference pose and the reference state.

12. The method of claim 9, wherein the first number of the first set of reference frames equals to the third number of the third set of reference frames and the second number of the second set of reference frames equals to the fourth number of the fourth set of reference frames.

13. The method according to claim 1, wherein the action model matches an application environment of the robot arm, and the application environment comprises at least one of the following: a virtual application environment and a reality application environment.

14. The method of claim 1, further comprising: adjusting the action to determine an action instruction for driving the robot arm.

15. An electronic device comprising:
at least one processing unit; and
at least one memory coupled to the at least one processing unit and storing instructions executed by the at least one processing unit, the instructions, when executed by the at least one processing unit, causing the electronic device to:
receive a language description for specifying a target implemented by the robot arm;
obtain a current state of the robot arm; and
determine, according to an action model, an action to be performed by the robot arm based on the language description and the current state, wherein the action model is pre-trained by reference data comprising related data of a character arm.

16. The electronic device of claim 15, wherein the electronic device is further caused to:
determine, according to the action model, image prediction of a scenario in which the robot arm performs the action based on the language description and the current state.

17. The electronic device of claim 16, wherein the electronic device is further caused to:
receive positions and the number of steps for specifying an action performed by the robot arm; and
determine, according to the action model, an action matching the positions and the number of the steps and the image prediction.

18. The electronic device of claim 15, wherein the current state of the robot arm comprises at least one of: an image of the robot arm, a pose of the robot arm, and a state of a tool of the robot arm, the action relating to a change in the pose and the state of the tool.

19. The electronic device of claim 16, wherein the action model comprises a language encoder, a state encoder, and an action decoder, and wherein the electronic device is further caused to determine the action by:
determining a language representation of the language description with the language encoder;
determining a state representation of the current state with the state encoder; and
determining, based on the language representation and the state representation, the action with the action decoder.

20. A non-transitory computer-readable storage medium having a computer program stored thereon, the computer program, when executed by a processor, causing the processor to:
receive a language description for specifying a target implemented by the robot arm;
obtain a current state of the robot arm; and
determine, according to an action model, an action to be performed by the robot arm based on the language description and the current state, wherein the action model is pre-trained by reference data comprising related data of a character arm.
